(19) United States
(12) Patent Application Publication
(10) Pub. No.: US 2012/0209960 A1
(43) Pub. Date: Aug. 16, 2012

(54) Controlling External Network-Media on a Local Network-UE Using an External Network-Connected UE

(75) Inventors: Olof Härwell, Stockholm (SE); Mikael Woxblom, Alvsjo (SE); Farjola Zaloshnja, Solna (SE)

(73) Assignee: TELEFONAKTIEBOLAGET L M ERICSSON (PUBL), Stockholm (SE)

(21) Appl. No.: 13/500,404

(22) PCT Filed: Oct. 6, 2009
(86) PCT No.: PCT/SE2009/051109

§ 371 Date: Apr. 5, 2012

(51) Int. Cl. G06F 15/16

(52) U.S. Cl. 709/217

(57) ABSTRACT

An external network-connected UE (1) is configured to control external network-media content in a local network-compliant UE (5) from the outside of the local network (7), via a Virtual control node (4) of a local network and a Media aggregating node (2), which both are configured to handle said external network-media content. The external network-connected UE communicates with the Media aggregating node, which, in turn, communicates with the Virtual Control node.

### TECHNICAL FIELD

The present invention relates to a method for a media aggregating node, for a virtual control node of a local network and for an external network-connected UE, of handling external network-media on a local network-UE, as well as to the media aggregating node, the virtual control node of the local network, and to the external network-connectable UE.

### BACKGROUND

A local network, e.g. a home network or an office network, may comprise several connected consumer electronic devices, e.g. personal computers, mobile phones, set-top-boxes and gaming consoles. Electronic devices within a local network can be adapted to communicate with each other e.g. according to DLNA (Digital Living Network Alliance) standard, which allows consumer electronic devices to communicate and share media content with each other, thereby enabling e.g. access of media files residing e.g. on a PC directly on a TV within the e.g. a DLNA home network, without a complicated configuration process.

A DLNA-compatible device is able to communicate with other DLNA-compatible devices within the DLNA network via the Universal Plug and Play (UPnP), which is a network protocol that is capable of establishing communication between DLNA-compatible devices within a DLNA network, without any configuration. By means of the UPnP, a DLNA device is able to e.g. discover and address other available DLNA devices within a DLNA network, and receive a description of their capabilities.

The DLNA compatible devices within a DLNA network are typically of different types, based on their function in the media distribution and rendering, and the types involve a DMS (Digital Media Storage/Server), a DMP (Digital Media Player), a DMR (Digital Media Renderer), and a DMC (Digital Media Controller). A DMS may be e.g. a PC (Personal Computer) or a NAS (Network Attached Storage), and it is a device that stores media content and makes it available to a wired and/or wireless networked DMP or DMR. A DMP may be e.g. a TV, a stereo, a game console, or a mobile phone, and is a device that finds content on a DMS and provides playback and rendering capabilities. Further, a DMC is a device that locates content on a DMS and plays it on a DMR, and a DMC may be e.g. a PDA (Personal Digital Assistant) or a mobile phone. Finally, a DMR is a device that plays content received from a DMC and it may be a TV, an audio/video receiver, a video display or remote speakers.

FIG. 1 illustrates a conventional DLNA network comprising four DLNA compatible devices, i.e. a DMP 5a, a DMR 5b, a DMS 5c and a DMC 5d. The DMC 5d is able to obtain a file structure from the DMS, and send a specific URL to DMR, the URL received from DMS file structure. The DMR 5b is able to connect to the specified URL, which in this case is the DMS 5c itself. Further, the DMP 5s is also able to obtain a file structure from DMS, and play a link given in the DMS file structure.

A DLNA network may also comprise various other DLNA compatible devices, such as e.g. a Digital Media Printer (DMPr), a Mobile Digital Media Uploader (M-DMU), a Mobile Digital Media Donwloader (M-DMD), a Mobile Network Connectivity Function (M-NCF), and Media Interoperability Unit (MIU).

A drawback with the DLNA is that the user-friendly setup mechanism leads to a decreased security, due to the lack of a default authentication mechanism.

Further, even though the amount of media content that is available on-demand e.g. on the Internet is increasing, the media exchange in a DLNA network is limited to the local devices within the network and to pre-stored media content, according to the UPnP architecture. Thus, access to the Internet, as well as to other external networks, is limited within a DLNA network, and external network-media content has to be downloaded and stored locally on a NAS or PC, in order to be accessible on a DLNA compatible TV or radio within the DLNA network.

Another drawback is the limited user interfaces capabilities in the UPnP, since a UPnP user interface can only be based on the file directory structure available via the DMS, and the metadata is limited to what can be derived from the actual files.

Thus, it is still presents a problem to enable an end-user to handle external network-media content, e.g. Internet media, in a local network, e.g. in a DLNA network, without downloading and storing the content locally.

### SUMMARY

The object of the present invention is to address the problem outlined above, and this object and others are achieved by the method and the arrangement according to the appended independent claims, and by the embodiments according to the dependent claims.

According to one aspect, the invention provides a method for a media aggregating node of handling external network-media in a local network-UE, and the external network-media is controlled by an external network-connected UE outside the local network. The external network-connected UE is connected to the media aggregating node, and the local network comprises a virtual control node connected to the media aggregating node. The media aggregating node performs the steps of:
Receiving presence information regarding local network-UEs from the virtual control node;
Receiving a user login from the external network-connected UE, from a user logged in to the virtual control node;
Sending requested information regarding external network-media to the external network-connected UE;
Sending requested information regarding local network-UEs to the external network-connected UE;
Receiving a user-selected control command associated with user-selected external network-media and with a user-selected local network-UE from the external network-connected UE, and forwarding to the virtual control node.

The media aggregating node may receive a trigger from the external network-connected UE to continuously forward updated presence information to said external-network UE, or return updated presence information regarding local network-UEs to the external network-connected UE, in response to a request.

The information regarding external network-media may further be obtained by the media aggregating node from one or more pre-selected content providers associated with said user.

According to a second aspect, the invention provides a method for a virtual control node in a local network of handling external network-media in a local network-UE, and the external network-media is controlled by an external network-connected UE outside the local network. The external network-connected UE is connected to a media aggregating node, which is connected to the virtual control node. The virtual control node performs the steps of:
Receiving presence information from the local network UEs, and forwarding to the media aggregating node;
Receiving a user-selected control command originating in the external network-connected UE via the media aggregating node, wherein the control command is associated with user-selected external network-media and with a user-selected local network-UE, and the user is logged in to the virtual control node and to the external network-connected UE;
Sending a corresponding control command to the user-selected local network-UE.

According to a third aspect, the invention provides a method for an external network-connected UE of controlling external network-media in a local network-UE, and the external network-connected UE is connected to a media aggregating node, which is connected to a virtual control node of the local network. The external network-connected UE performs the steps of:
Sending user login information to the media aggregating node;
Receiving requested information regarding external network-media from the media aggregating node;
Receiving requested information regarding local network-UEs from the media aggregating node, said information originating in a virtual control node, to which said user is logged in, and
Sending a user-selected control command associated with user-selected external network-media and with a user-selected local network-UE to the media aggregating node.

According to a fourth aspect, the invention provides a media aggregating node arranged to handle external network-media in an local network-UE, and the external network-media is controlled by an external network-connected UE outside the local network and connectable to the media aggregating node. The local network comprises a virtual control node connectable to the media aggregating node, which comprises:
A device for communicating with the external network-connected UE, the device arranged to receive a login from a user, to send requested information regarding external network-media, to send requested information regarding local network-UEs, and to receive a user-selected control command associated with user-selected external network-media and with a user-selected local network-UE;
A device for communicating with the virtual control node, the device arranged to receive presence information regarding local network-UEs, and to forward the received user-selected control-command, wherein said user is logged in to the virtual control node.

The media aggregating node may further comprise means for communicating with a content data sub-node for obtaining information regarding external network-media from one or more pre-selected content providers, which are stored in the media aggregating node in association with a user.

According to a fifth aspect, the invention provides a virtual control node for a local network arranged to handle external network-media in a local network-UE. The external network-media shall be controlled by an external network-connected UE outside the local network and connectable to a media aggregating node, which, in turn, is connectable to the virtual control node, which comprises:
A device for communicating with the local network UEs, the device arranged to receive presence information, and to send a user-selected control-command originating in the external network-connected UE. The control-command is associated with user-selected external network-media and with a user-selected local network-UE, wherein said user is logged in to the virtual control node and to the external network-connected UE;
A device for communicating with the media aggregating node, the device arranged to forward said received presence information, and to receive said user-selected control-command.

According to a sixth aspect, the invention provides an external network-connectable UE arranged to control external network-media in a local network-UE from the outside of the local network. The external network-connectable UE is further connectable to a media aggregating node, which is connectable to a virtual control node of the local network. The external network-connectable UE comprises a device for communicating with a media aggregating node, and the device is arranged to send user login information, to receive requested information regarding external network-media, and to receive requested information regarding local network UEs, wherein said information is forwarded from a virtual control node to which said user is logged in. The device is further arranged to send a user-selected control command associated with user-selected external network-media and with a user-selected local network-UE to the media aggregating node.

The external network-connectable UE may further comprise a display for displaying the received information regarding external network-media and local network-UEs, and user input means for initiating a sending of the login information and of the control command.

The device for communicating with a media aggregating node is further arranged to send a request for updates, and receive updated presence information regarding local network-UEs in return, and the information is forwarded from the virtual control node.

The local network may be a DLNA-network, and the local network-UEs DLNA-compatible. Further, the external network may be the Internet, and the external network-connectable UE connectable to the Internet.

An advantage with the present invention is that the external network-connected UE is able to act as a custom-optimized navigation client, without the restrictions imposed on the devices of the local network. Further, the external network-media files do not have to be downloaded locally prior to playing, but can be streamed on-demand directly to the local network-UEs.

### BRIEF DESCRIPTION OF THE DRAWINGS

The present invention will now be described in more detail, and with reference to the accompanying drawings, in which:

FIG. 1 schematically illustrates a conventional DLNA home network;

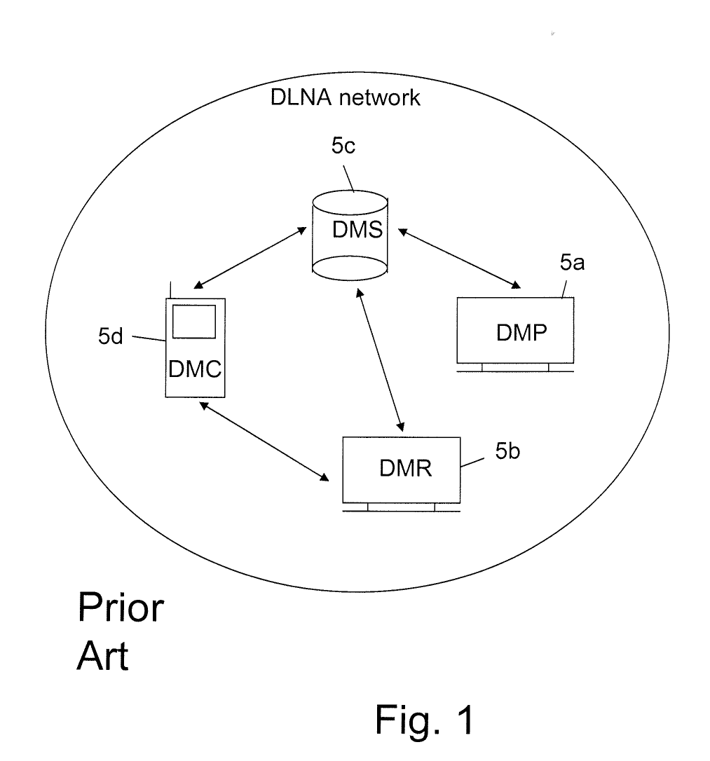

FIG. 2 is a block diagram schematically illustrating a local network, in particular a DLNA network, comprising a Virtual Control node, which is connected to a Media Aggregating node, and an external network-connected UE for controlling external network-media content e.g. a DMR within the DLNA network, according to an exemplary embodiment of the invention;

FIG. 3 is a signalling diagram illustrating an Internet-connected UE controlling Internet-media content in a DLNA compatible device within a DLNA network, according to an exemplary embodiment of the invention;

FIG. 4 is a flow diagram showing an external network-connected UE controlling external network-media content in a local network-compatible UE;

FIG. 5 is a flow diagram showing a media aggregating node handling external network-media content in a local network-UE;

FIG. 6 is a flow diagram showing a virtual control node handling external network-media content in a local network-UE;

FIG. 7 illustrated schematically an exemplary external-network-connectable UE, according to this invention;

FIG. 8 illustrated schematically an exemplary Media Aggregating node and an exemplary Virtual Control node, according to this invention.

### DETAILED DESCRIPTION

In the following description, the invention will be described in more detail with reference to certain embodiments and to accompanying drawings. For purposes of explanation and not limitation, specific details are set forth, such as particular scenarios, techniques, etc., in order to provide a thorough understanding of the present invention. However, it is apparent to one skilled in the art that the present invention may be practised in other embodiments that depart from these specific details.

Moreover, those skilled in the art will appreciate that the functions and means explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as in a system comprising a computer processor and a memory coupled to the processor, wherein the memory is encoded with one or more programs that may perform the functions disclosed herein.

In the following, the term local network-UE (User Equipment) is defined as a device that is capable of operating in a local network and communicating with the other devices in the local network, e.g. in a DLNA network. The term external network is defined as another network than the local network, and the term external network-connectable UE or external network-connected UE is defined as a device that is capable of communicating with this external network. According to a preferred embodiment of the invention, the external network corresponds to the Internet, but this invention is not limited thereto.

Conventionally, a DLNA network comprises one or more DMS (Digital Media Storage/Server) for storing media content, and the available media content can be presented to a user on a DMC (Digital Media Controller), typically in the form of tree structure. Thereafter, a user-selected media content, such as video- or audio-media or an image, can be made available by the user to be played or rendered on a DMP (Digital Media Player) or on a DMR (Digital Media Renderer).

However, according to this invention, an external-network-connected UE (User Equipment), such as e.g. an Internet-connected mobile phone or a PC located outside the local network, is used for controlling and navigating media content hosted on said external network via a media aggregating node, and for pushing the external network-media directly to a local network-compatible UE, e.g. to a DLNA-compatible PC, TV or radio, via a virtual control node of the local network. The media aggregating node comprises media servers, e.g. for authenticating users logged in to the UE and users logged in to the virtual control node of the local network, and the virtual control node controls and communicates with the local network-compliant devices of the local network. The external network-connected UE communicates with the media aggregating node, which, in turn, communicates with the virtual control node of the local network. Thereby, the external network-connected UE is able to function as a custom-optimized navigation client, without the restrictions imposed e.g. by the DLNA and the UPnP. Further, the external network-media files can be streamed on-demand to the local network-UEs, and do not have to be downloaded locally prior to playing.

In an exemplary use-case according to an embodiment of the present invention, according to which the local network is a DLNA network, and the external network is the Internet, a user is logged in on an Internet-connected UE, such as e.g. a mobile phone or a PC. Thereafter, the user sends a request to the media aggregating node for information regarding e.g. available and popular radio news programs from a pre-selected Internet-media content provider. In response, the user receives a list comprising short descriptions, thumbnails and various additional metadata, provided by the Internet-media content provider via the content data-node and the media aggregating node. The user sends a selection of a particular news program to play, and receives a list of available and suitable devices within the DLNA network in return. This list is obtained by the virtual control node within the DLNA network, and forwarded to the user via the media aggregating node to the DLNA network. The user selects e.g. a DLNA-compatible radio located in the living room, and sends a control command to the media aggregating node indicating the selected news program and the selected radio in the living room, and the news program is immediately played on said radio in his living room. Further, the user is able to change volume, stop and resume playing by sending further control commands from said Internet-connected UE.

Thus, the present invention is implemented by means of a Media aggregating node (MA), a Virtual control node (VC), and of an external network-connectable UE, e.g. an Internet-connectable UE (IC UE), as described below:

A media aggregating node, e.g. a Media Aggregator, comprises media servers that are responsible for authenticating the user, for processing all requests and presence messages, for storing data and making the user profile available, and for handling media and device metadata to be displayed on the external network-connected UE. The media aggregating node is able to communicate with the external network-connected UE, with the external network-media content providers via a content data sub-node, and with the virtual control node of a local network, e.g. a DLNA network.

A virtual control-node is located within a local network and acts e.g. as a DMC (Digital Media Controller) in a DLNA network for communicating presence and control messages to the local network-compatible UEs within the local network. The virtual control node communicates with the UEs within the local network (e.g. according to the UPnP), and with the media aggregating node. According to an exemplary implementation, the virtual control node communicates with the media aggregating node via a Home Gateway, and could be co-located with the Home Gateway node.

An external network-connectable UE, e.g. a PC or a mobile phone, is capable of displaying available external network-media content and available and suitable local network-compatible UEs within the local network to a user, thereby enabling the user to select a external network-media content and an available local network-compatible UE, and send a control command, e.g. to start playing the selected media content on the selected local network-compatible UE within the local network.

Other nodes that are involved in the implementation of the present invention are the following:

A content data-node owned by the Internet-media content providers, for publishing the available media titles and their respective URL's, by communicating with the media aggregating node.

A streaming server-node for providing a media stream to the local network-UEs.

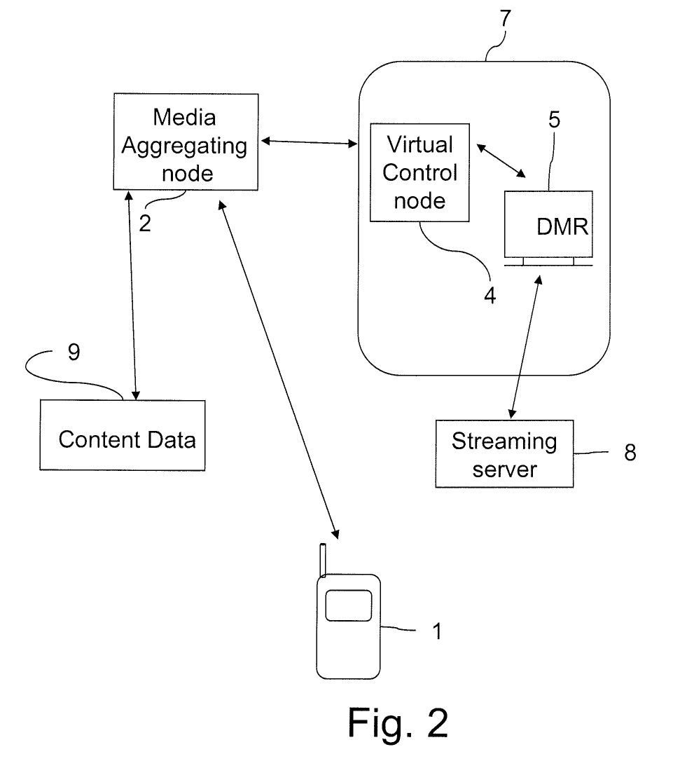

The above-described nodes are all illustrated in FIG. 2, which is a block diagram schematically illustrating a DLNA network 7 comprising a Virtual Control node 4 and a DMR (Digital Media Renderer) 5. The Virtual Control node is communicating with a Media Aggregating node 2, e.g. via a Home Gateway (not illustrated in the figure), and the Media Aggregating node is communicating with a Internet-connected UE 1 outside the DLNA network, and enabling the UE to control Internet media content in the DMR within the DLNA, the media stream provided to the DMR by a streaming server 8. The Media Aggregating node is further communicating with a content data-node 9 in order to obtain available media titles and their respective URLs.

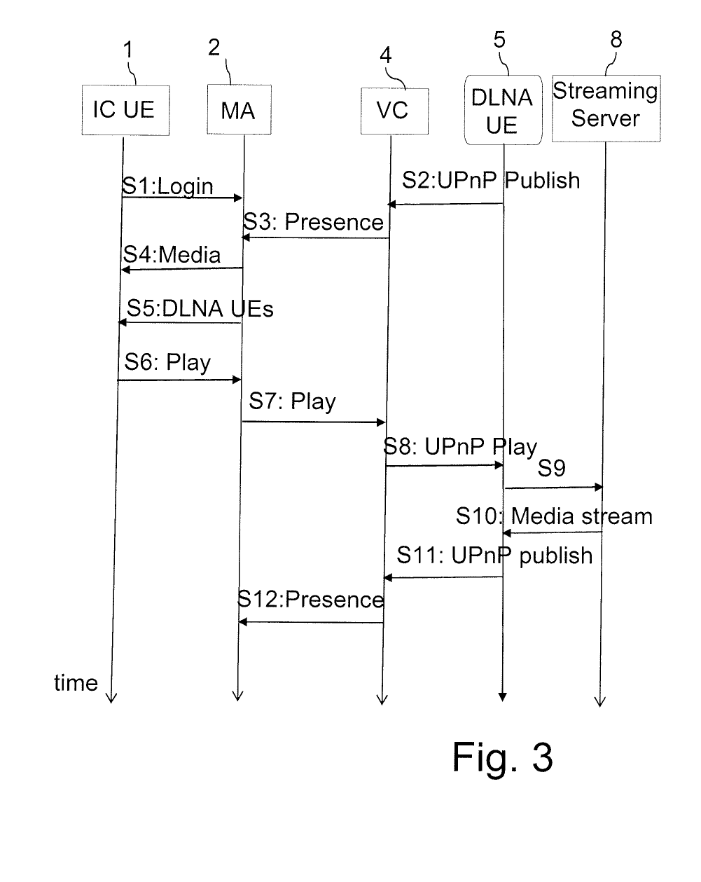

FIG. 3 is a signalling diagram illustrating how an Internet-connected UE 1 controls Internet-media content in a DLNA UE 5, according to an exemplary embodiment of the invention.

In signal S1, the IC-UE 1 logs in to the MA 2 (media aggregating node) by sending user name and password. In S2, the DLNA UE sends a UPnP Publish to the VC 4 comprising presence information, e.g. that it is available. The VC, in turn, forwards the presence information to the MA, in S3. In signal S4, the MA sends information regarding Internet media content to the IC UE, after receiving a request from the IC UE, and the Internet media content-information has been obtained by the MA from a content-provider via a content data-node (not illustrated in the diagram). Further, in S5, the MA sends information regarding available and suitable DLNA UEs to the IC UE, after receiving a request, and further having determined that the logged in user is also logged in/registered in the VC.

Using the received information, the user is able to select an Internet media content and a DLNA UE, and to further select a control command to send to the MA, in signal S6, using the IC UE, the control command being e.g. a play-command or a stop-command. This control command is forwarded by the MA to the VC, in S7, and forwarded, in S8, as a corresponding UPnP Play command to the selected DLNA UE. In S9 and S10, the DLNA UE obtains the media stream associated with the selected Internet media content from the streaming server, and issues a UPnP Publish with the play status for the VC, in S11. The VC, in turn, forwards the updated presence information to the MA, in signal S12.

The media aggregating node 2, according to this invention, receives status and presence information from the local network-UEs of the local network via the virtual control node 4. When a user is logged in to an external network-connected UE 1 outside the local network 7, the media aggregating node receives a user login from the external network-connected UE. The media aggregating node authenticates the user, and sends information regarding external network-media to the external network-connected UE, in response to a request. Further, it determines whether the user is also logged in to a virtual control node, with which the media aggregating node is communicating. If so, the media aggregating node will send information regarding available and suitable local network-UEs to the external network-connected UE, in response to a request. When the media aggregating node receives a user-selected control command associated with a selected external network-media and a selected local network-UE from the external network-connected UE, it will forward the control command to the virtual control node.

According to different exemplary embodiments of this invention, a control command is directed e.g. to start playing or stop playing a selected media session, to change the volume of a played session, or to resume playing a media session after a pause.

According to a further exemplary embodiment, the media aggregating node receives a request for updated presence information regarding the local network-UEs from the external network connected UE, e.g. after receiving a control command, and sends updated presence information in return. According to an alternative embodiment, the media aggregating node receives a trigger when the external network-connected UE logs in to continuously forward any updated presence information to the external network-connected UE.

According to an exemplary embodiment of the invention, said information regarding external network-media is obtained by the media aggregating node from one or more pre-selected content providers stored in the media aggregating node associated with said user.

The virtual control node 4 controls and communicates with the local network-compliant devices 5 of the local network, e.g. using the UPnP in case the local network is a DLNA network, and receives presence information to forward to the media aggregating node 2, which has authenticated the logged-in user. The virtual control node will receive a user-selected control command from the media aggregating node 2, the control command originating in the external network-connected UE 1 and associated with a user-selected external network-media content and with a user-selected local network-UE. The virtual control node will send a corresponding local network-adapted control command to the selected local network-UE, such that a received play-command associated with a selected media session and with a selected local network UE will cause said media session to be played on said local network UE.

The external network-connected UE 1 communicates with the media aggregating node 2, and sends user login information to the media aggregating node, and receives information regarding external network-media from the media aggregating node, in response to a request. In case the user is also logged in to a virtual control node of a local network, the external network-connected UE will receive information regarding available and suitable local network-UEs from the media aggregating node, in response to a request, and this presence information is forwarded from said virtual control node. Next, the external network-connected UE will send a user-selected control command associated with selected external network-media and with a selected local network-UE to the media aggregating node, to be forwarded to the virtual control node.

According to a further exemplary embodiment, the external-network-connected UE sends a request for updated presence information regarding the local network-UEs to the media aggregating node, e.g. after sending a control command, and receives the updated presence information in return. According to an alternative embodiment, the external network-connected UE triggers the media aggregating node at log-in to continuously forward any updated presence information to the external network-connected UE.

According to a preferred embodiment, said external network is the Internet, and the external network-connected UE is connected to the Internet.

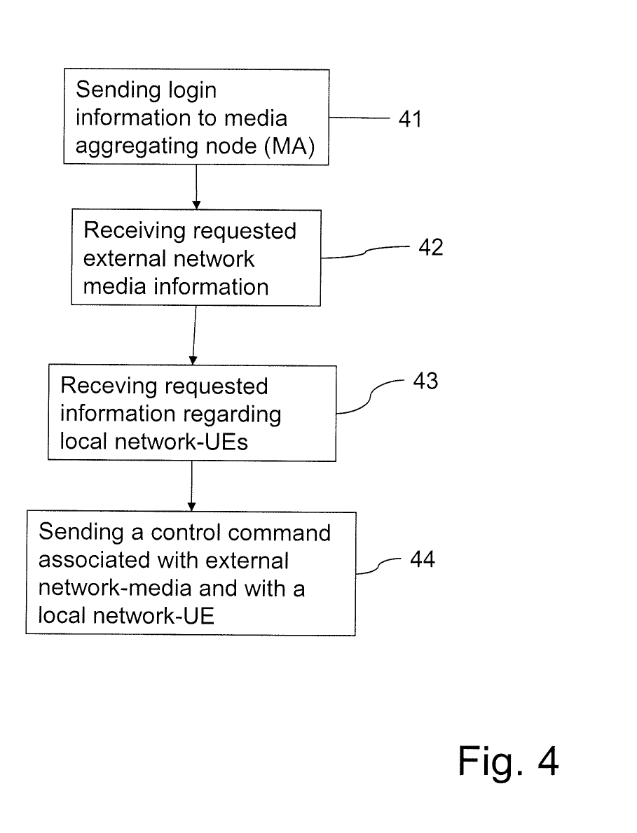

FIG. 4 is a flow diagram showing an external network-connected UE controlling external network-media content in a local network-compatible UE, according to the invention, by communicating with a media aggregating node.

The external-network connected UE sends login information to the media aggregating node, in step 41, and will receive requested information regarding external network media content, in step 42. Next, the UE will receive requested information regarding local network-UEs in step 43, e.g. a list of the local network-UEs that are available and suitable for a specific media content. Now, the external network-connected UE is able to send a user-selected control command to the media aggregating node, in step 44, e.g. to start playing a selected media session on a selected local network-UE.

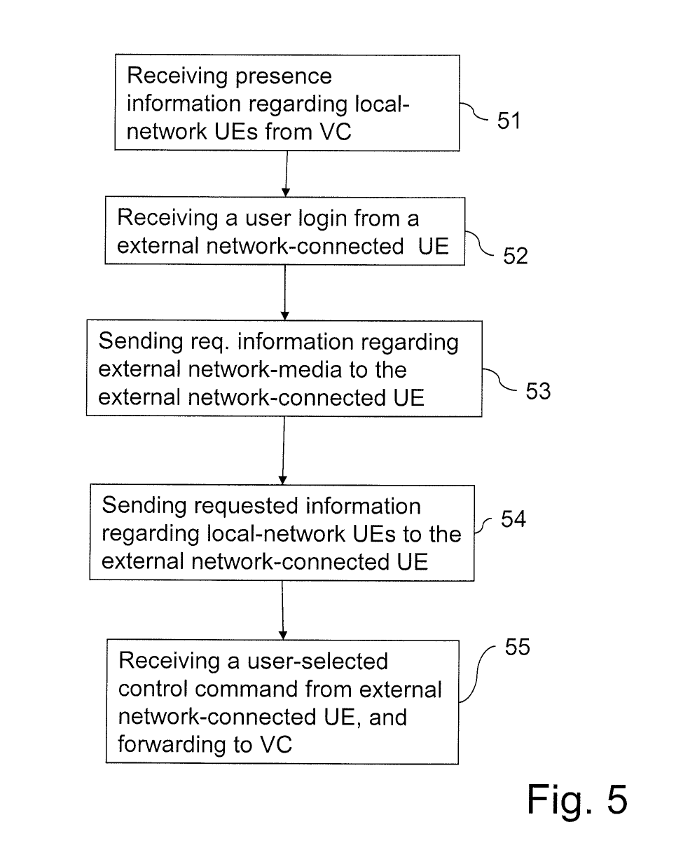

FIG. 5 is a flow diagram showing a media aggregating node handling external network-media content in a local network-UE, according to the invention, by communication with a virtual control node of the local network, and with an external-network connected UE that is controlling the media content from the outside of the local network.

In step 51, the media aggregating node receives presence information regarding local network-UEs from the Virtual Control node. In step 52, a user login is received form an external network-connected UE, and the media aggregating node sends information regarding external network media-content to the external network connected UE, in step 53, after receiving a request. Further, the media aggregating node sends information regarding local network-UEs to the external network UE, in step 54, e.g. a list of local network-UEs that are available and suitable for playing a specific media content, after receiving a request, and after having determined that the logged-in user is also logged-in to the local network. Finally, in step 55, the media aggregating node receives a user-selected control command from the external network-connected UE, selecting an external network media content, and a local network-UE, and forwards the control command to the Virtual control node.

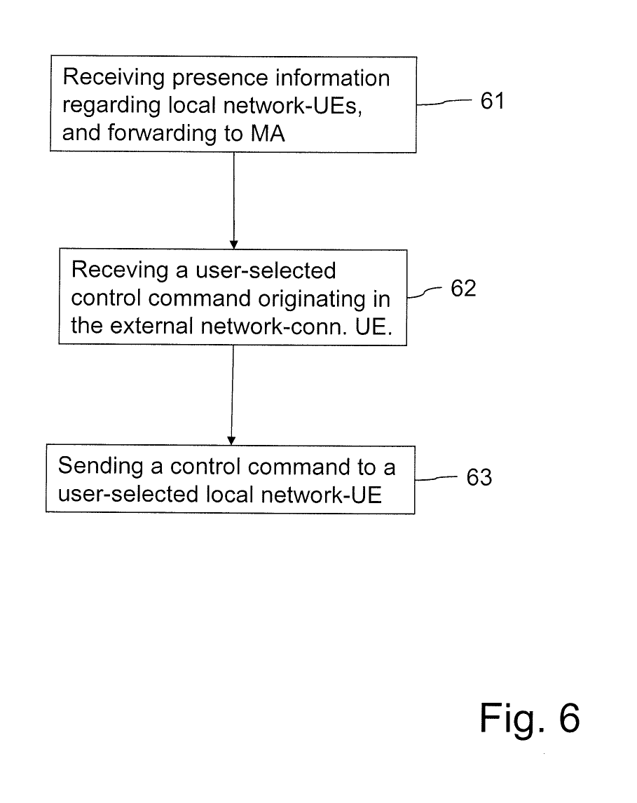

FIG. 6 is a flow diagram showing a Virtual Control node of a local network handling external network-media content in a local network-UE, according to the invention, the Virtual Control node communicating with a media aggregating node and with the local network-UEs of the local network,

In step 61, the Virtual Control node receives presence and status information from local network-UEs, and forwards the information to the media aggregating node. In step 62, the Virtual Control node receives a user-selected control command from the media aggregating node, the control command originating in an external network-connected UE handled by a user that is also logged in to the Virtual control node. Further, the control command, e.g. a play-command, is associated with a user-selected external network-media content and with a user-selected local network-UE of the local network. Next, in step 63, the Virtual Control node sends a corresponding local network-adapted control command to the selected local network-UE, e.g. a UPnP Play, in case the local network is a DLNA network.

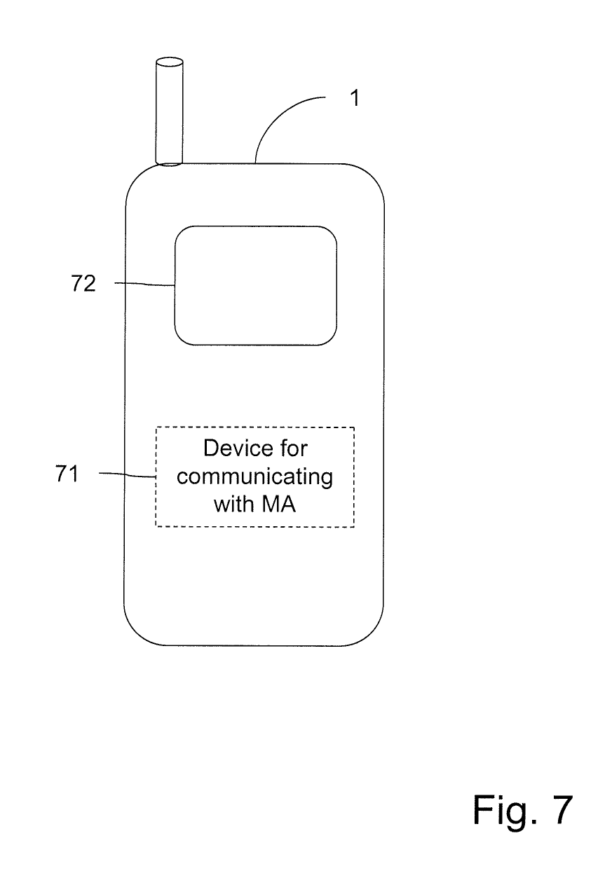

FIG. 7 illustrated schematically an exemplary external-network-connectable UE, according to this invention, e.g. a PC (Personal Computer) or a mobile phone, adapted to communicate with the external network, e.g. the Internet. The UE is provided with a device 71 for communicating with a media aggregating node, as well as with a display 72 for displaying available external network-media content and available local network-compatible UEs within the local network to a user in order to enable the user to select a media content and an available local network-UE. The UE is further provided with a suitable user input means (not illustrated in the figure) for initiating the UE to send log-in information and control commands to the media aggregating node, e.g. to start playing the selected media content on the selected local network UE.

The device 71 for communication with the media aggregating node further comprises a sender and a receiver. The sender is further arranged to send user login information to the media aggregating node, and to send a user-selected control command associated with user-selected external network-media and with a user-selected local network-UE to the media aggregating node. The receiver is arranged to receive information regarding external network-media from the media aggregating node, in response to a request, and information regarding available local network-UEs from the media aggregating node, in response to a request, wherein said information regarding local network-UEs is forwarded from a virtual control node, to which said user is logged in.

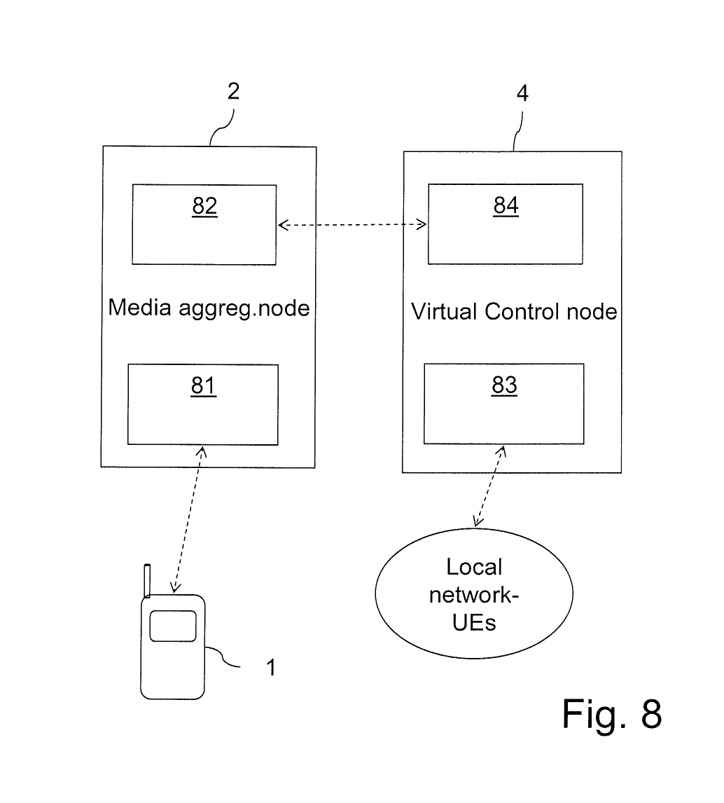

FIG. 8 illustrated schematically an exemplary Media Aggregating node 2 and an exemplary Virtual Control node 4, according to this invention.

The media aggregating node 2 and comprises media servers that are responsible for authenticating the user, for processing all requests and presence messages, for storing data and making the user profile available, and for handling media and device metadata to be displayed on a external-network connected UE. The media aggregating node comprises a device 81 for communicating with the external network-connected UE 1, said device comprising a receiver arranged to receive a login from a user and a user-selected control command associated with user-selected external network-media and with a user-selected local network-UE, as well as a sender arranged to send information regarding external network-media and presence information regarding available and suitable local network-UEs to the user, in response to received requests. The media aggregating node is further provided with a device 82 for communication with the virtual control node 4, said device comprising a receiver arranged to receive presence information regarding local network-UEs, and a sender arranged to forward the received user-selected control-command, wherein the user is logged in to the virtual control node.

A media aggregating node according to a further exemplary embodiment is provided with means for storing pre-selected content providers associated with a user, as well as with a device for communicating with a content data sub-node for obtaining information regarding external network-media from said content providers.

The virtual control node 4 act as a controller of the local network, e.g. as a DMC (Digital Media Controller) of a DLNA, for communicating e.g. presence messages and control commands to the UEs within the local network. The virtual control node is provided with a device 83 for communicating with the local network UEs, the device comprising a receiver arranged to receive presence information related to the local network UEs, and a sender arranged to forward a user-selected control-command to a selected local network UE. Said control command originates in the external network-connected UE, and is associated with user-selected external network-media and with a user-selected local network-UE, wherein said user is logged in to the virtual control node and to the external network-connected UE. The Virtual control node is further provided with a device 84 for communicating with the media aggregating node 2, the device comprising a sender arranged forward said received presence information, and a receiver arranged to receive said user-selected control-command.

It should be noted that the external network-connectable UE 1, the Media Aggregating node 2 and the Virtual Control node 4, as illustrated in FIGS. 7 and 8, may be implemented by physical or logical entities using software functioning in conjunction with a programmed microprocessor or general purpose computer, and/or using an application specific integrated circuit (ASIC).

Further, the above mentioned and described embodiments are only given as examples and should not be limiting to the present invention. Other solutions, uses, objectives, and functions within the scope of the invention as claimed in the accompanying patent claims should be apparent for the person skilled in the art.

### Abbreviations

DLNA Digital Living Network Alliance
DLNA UE DLNA-compliant User Equipment
DMC Digital Media Controller
DMP Digital Media Player
DMS Digital Media Storage/Server
DMR Digital Media Renderer
UPnP Universal Plug and Play
MA Media Aggregating node
VC Virtual Control node
IC UE Internet-connected User Equipment

1.-20. (canceled)

21. A method of handling external network media in a local network user equipment (UE), the external network media being controlled by an external network-connected UE that is outside the local network and is connected to a media aggregating node, the local network comprising a virtual control node connected to the media aggregating node, the method comprising the media aggregating node:
receiving presence information regarding local network UEs from the virtual control node;
receiving a user login from a user of the external network-connected UE, the user being logged in to the virtual control node;
sending requested information regarding external network media to the external network-connected UE;
sending requested information regarding local network UEs to the external network-connected UE;
receiving from the external network-connected UE a user-selected control command associated with user-selected external network media and with a user-selected local network UE, and forwarding the command to the virtual control node.

22. The method of claim 21 further comprising the media aggregating node receiving a trigger from the external network-connected UE to continuously forward updated presence information to the external network-connected UE.

23. The method of claim 21 further comprising the media aggregating node:
receiving a request for updates from the external network-connected UE; and
returning updated presence information regarding local network UEs.

24. The method of claim 21 further comprising the media aggregating node obtaining the information regarding external network-media from one or more pre-selected content providers associated with the user.

25. A method, for a virtual control node in a local network, of handling external network media in a local network user equipment (UE), the external network media being controlled by an external network-connected UE that is outside the local network and connected to a media aggregating node, the media aggregating node connected to the virtual control node, the method comprising the virtual control node:
receiving presence information from the local network UEs, and forwarding the received presence information to the media aggregating node;
receiving, via the media aggregating node, a user-selected control command originating in the external network-connected UE, wherein the control command is associated with user-selected external network media and with a user-selected local network UE, and wherein the user is logged in to the virtual control node and to the external network-connected UE;
sending a corresponding control command to the user-selected local network UE.

26. The method of claim 25 wherein the local network is a DLNA-network, and the local network UEs are DLNA-compatible.

27. A method of controlling, by an external network-connected user equipment (UE), external network media in a local network UE, the external network-connected UE being connected to a media aggregating node which is connected to a virtual control node of the local network, the method comprising the external network-connected UE:
sending user login information for a user to the media aggregating node;
receiving requested information regarding external network-media from the media aggregating node;
receiving requested information regarding local network-UEs from the media aggregating node, the information originating in the virtual control node, and the user being logged in to the virtual control node,
sending a user-selected control command associated with user-selected external network-media and with a user-selected local network UE to the media aggregating node.

28. The method of claim 27 further comprising the external network-connected UE sending a trigger to the media aggregating node to continuously forward updated presence information to the external network-connected UE.

29. The method of claim 27 further comprising the external network-connected UE:
sending a request for updates to the media aggregating node;
receiving updated presence information regarding local network UEs in return, the information being forwarded from the virtual control node.

30. The method of claim 27 further comprising the media aggregating node obtaining the information regarding external network-media from one or more pre-selected content providers associated with the user.

31. The method of claim 27 wherein the external network is the Internet, and the external network-connected UE is connected to the Internet.

32. A media aggregating node configured to handle external network-media in a local network user equipment (UE), the media aggregating node being controllable by an external network-connected UE that is outside the local network and is connectable to the media aggregating node, the local network comprising a virtual control node connectable to the media aggregating node, the media aggregating node comprising:
a first device configured to:
receive a login from a user of the external network-connected UE;
send requested information regarding external network-media to the external network-connected UE;
send requested information regarding local network-UEs to the external network-connected UE;
receive from the external network-connected UE a user-selected control command associated with user-selected external network-media and with a user-selected local network-UE;
a second device configured to:
receive presence information regarding local network-UEs from the virtual control node;
forward to the virtual control node the received user-selected control-command, wherein the user is logged in to the virtual control node.

33. The media aggregating node of claim 32 wherein the first device is further configured to receive a request for updates, and correspondingly return updated presence information regarding local network UEs.

34. The media aggregating node of claim 32:
further comprising a circuit for communicating with a content data sub-node to obtain information regarding external network-media from one or more pre-selected content providers;
the media aggregating node configured to store the obtained information in the media aggregating node in association with a user.

35. A virtual control node for a local network arranged to handle external network-media in a local network user equipment (UE), to be controlled by an external network-connected UE that is outside the local network and is connectable to a media aggregating node, the media aggregating node being connectable to the virtual control node, the virtual control node comprising:
a first device configured to:
receive presence information from local network UEs; and
send to a user-selected local network UE a user-selected control-command that originates in the external network-connected UE and that is associated with user-selected external network-media and with a user-selected local network UE, wherein the user is logged in to the virtual control node and to the external network-connected UE; and
a second device configured to:
forward the received presence information to the media aggregating node;
receive the user-selected control-command from the media aggregating node.

36. The virtual control node of claim 35 wherein the local network is a DLNA-network, and the local network UEs are DLNA-compatible.

37. An external network-connectable user equipment (UE) configured to control external network media in a local network UE from the outside of the local network, the external network-connectable UE being further connectable to a media aggregating node that is connectable to a virtual control node of the local network, the external network-connectable UE comprising a device configured to:
send user login information to a media aggregating node;
receive requested information regarding external network-media from the media aggregating node;
receive requested information regarding local network UEs from the media aggregating node, wherein the information is forwarded from a virtual control node to which the user is logged in; and
send to the media aggregating node a user-selected control command associated with user-selected external network-media and with a user-selected local network-UE to the media aggregating node.

38. The external network-connectable UE of claim 37, further comprising:
a display for displaying the received information regarding external network-media and local network UEs;
a user input device for initiating a sending of the login information and of the control command.

39. The external network-connectable UE of claim 37, wherein the device is further configured to:
send a request for updates to the media aggregating node;
receive updated presence information regarding local network-UEs in return, the information being forwarded from the virtual control node.

40. The external network-connectable UE of claim 37, wherein the external network is the Internet, and the external network-connectable UE is connectable to the Internet.
